(19) United States
(12) Patent Application Publication
(10) Pub. No.: US 2019/0132677 A1
(43) Pub. Date: May 2, 2019

(54) SIGNAL PROCESSING DEVICE, SIGNAL PROCESSING METHOD, AND SPEAKER DEVICE

(71) Applicant: Onkyo Corporation, Osaka (JP)

(72) Inventors: Hiroki KUROSAKI, Osaka (JP); Tsuyoshi KAWAGUCHI, Osaka (JP); Yoshinori NAKANISHI, Osaka (JP); Norimasa KITAGAWA, Osaka (JP)

(21) Appl. No.: 16/171,488

(22) Filed: Oct. 26, 2018

(30) Foreign Application Priority Data
Oct. 27, 2017 (JP) 2017-208219

(51) Int. Cl. H04R 3/04

(52) U.S. Cl. CPC H04R 3/04; H04R 2430/01

(57) ABSTRACT

A signal processing device configured to perform: low pass filter processing to extract a low frequency component of an audio signal, compression processing to compress the audio signal to which the low pass filter processing is performed in a case that the audio signal to which the low pass filter processing is performed is not less than a predetermined signal level, high pass filter processing to extract high frequency component of the audio signal, first volume processing to attenuate the audio signal, and synthesis processing to synthesize the low frequency component of the audio signal to which the compression processing is performed and high frequency component of the audio signal.

### CROSS-REFERENCE TO RELATED APPLICATIONS

This application claims priority to Japanese Application No. 2017-208219, filed Oct. 27, 2017, the entire contents of which are incorporated herein by reference.

### FIELD

The present disclosure relates to a signal processing device that performs signal processing to an audio signal, a signal processing method, and a speaker device that includes the signal processing device.

### BACKGROUND

A speaker device that outputs audio includes a signal processing device (for example, DSP (Digital Signal Processor) that performs signal processing to an audio signal. In the speaker device that includes a small diameter speaker, there is a case where the audio signal is compressed by the signal processing device since the distortion component is included in output audio by excess amplitude of a speaker diaphragm remarkably, or in order to suppress failure of speaker reproducing audio that abnormal sound occurs in output audio. FIG. 19 is a graph illustrating compression proceeding by the signal processing device. A horizontal axis illustrates input. A vertical axis illustrates output. For example, in a case that a threshold is set to threshold 1 illustrated in FIG. 19, the audio signal that excesses threshold 1 is compressed. Further, in a case that a threshold is set to threshold 2 illustrated in FIG. 19, the audio signal that excesses threshold 2 is compressed.

Herein, as result of earnest research, in the audio signal, inventors discovers that amplitude of the speaker diaphragm becomes large and the speaker reproducing audio fails immediately even if input voltage is low as a frequency lowers. This is because amplitude of the speaker diaphragm becomes large in the low frequency which is not more than the lowest resonance frequency f0 at which reproduction sound pressure level becomes high in higher frequency. For this reason, when the audio signal level leading to limit of amplitude of the speaker diaphragm in the low frequency (hereinafter refereed as to “failure point”) is set to a threshold of compression processing, the signal is excessively compressed in the middle and high frequency. Therefore, the inventors have found out that the other band is not compressed wastefully and volume can be added if compression processing is performed to the low frequency component of the audio signal. In JP 2007-104407 A (see FIG. 1), volume sense is tried to be increased by performing compression processing to the audio signal to which low pass filter processing that extracts the low frequency component of the audio signal is performed.

Further, in the speaker device, there are cases where low frequency equalizing processing to boost the low frequency component of the audio signal to extend frequency characteristics of the speaker to low frequency is performed as illustrated in FIG. 20.

In a case that the above described low frequency equalizing processing is performed, it is necessary to attenuate the audio signal so that amplitude of the speaker diaphragm does not reach failure point. However, when all the bands of the audio signal is attenuated, volume of the middle and high frequency of the audio signal is in short in reproduction sound from the speaker.

### SUMMARY

According to one aspect of the disclosure, there is provided a signal processing device configured to perform: low pass filter processing to extract a low frequency component of an audio signal, compression processing to compress the audio signal to which the low pass filter processing is performed in a case that the audio signal to which the low pass filter processing is performed is not less than a predetermined signal level, high pass filter processing to extract high frequency component of the audio signal, first volume processing to attenuate the audio signal, and synthesis processing to synthesize the low frequency component of the audio signal to which the compression processing is performed and high frequency component of the audio signal.

### BRIEF DESCRIPTION OF THE DRAWINGS

FIG. 1 is a block diagram illustrating a constitution of a speaker device according to an embodiment of the present invention.

FIG. 2 is a diagram illustrating signal processing by a DSP in a first embodiment.

FIG. 3 is a diagram illustrating conventional volume processing.

FIG. 4 is a diagram illustrating relationship between first volume processing and second volume processing.

FIG. 5 is a diagram illustrating amplitude of a speaker diaphragm against a frequency of an audio signal to which low frequency EQ processing is performed.

FIG. 6 is a diagram illustrating a state that volume is raised from the state of FIG. 5.

FIG. 7 is a diagram illustrating an audio signal to which DRC processing is performed.

FIG. 8 is a diagram illustrating addition of volume by the second volume processing.

FIG. 9 is a diagram illustrating signal processing by the DSP in a variation 1 of the first embodiment.

FIG. 10 is a diagram illustrating signal processing by the DSP in a variation 2 of the first embodiment.

FIG. 11 is a diagram illustrating amplitude in the first embodiment when reproducing in stereo.

FIG. 12 is a diagram illustrating signal processing by the DSP in a second embodiment.

FIG. 13 is a graph illustrating signal level in the first embodiment.

FIG. 14 is a graph illustrating signal level in the second embodiment.

FIG. 15 is a diagram illustrating signal processing by the DSP in a third embodiment.

FIG. 16 is a graph illustrating an audio signal to which monaural synthesis processing is performed.

FIG. 17 is a diagram illustrating signal processing by the DSP in a fourth embodiment

FIG. 18 is a graph that phase−amplitude characteristics of “L/2−R/2” are over-written to FIG. 15.

FIG. 19 is a graph illustrating compression processing by a signal processing device.

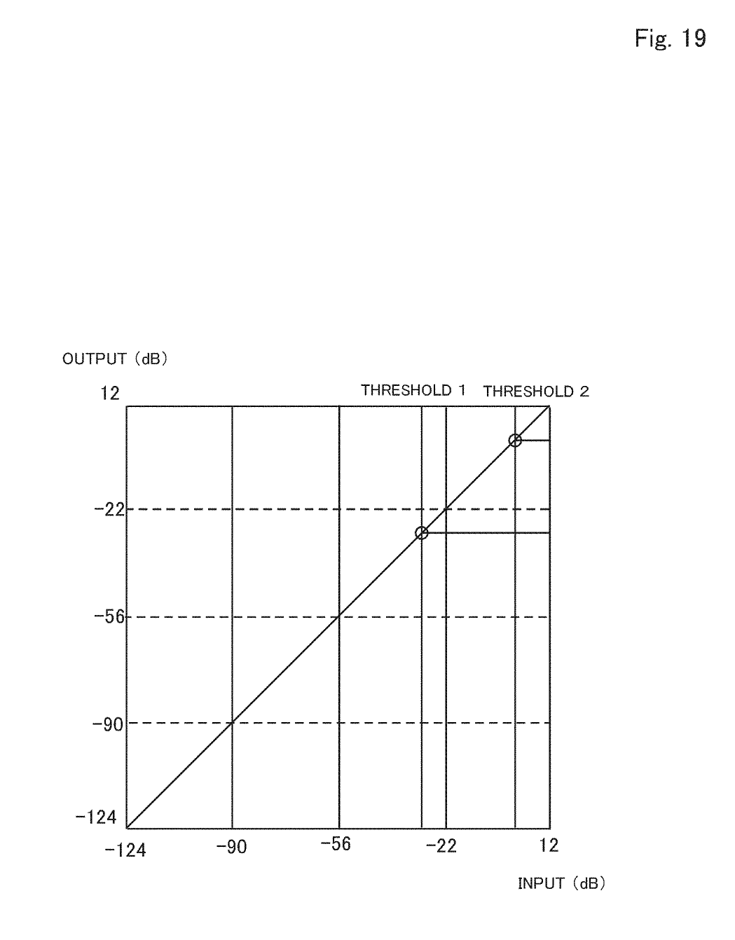

FIG. 20 is a diagram illustrating an audio signal to which low frequency equalizing processing is performed.

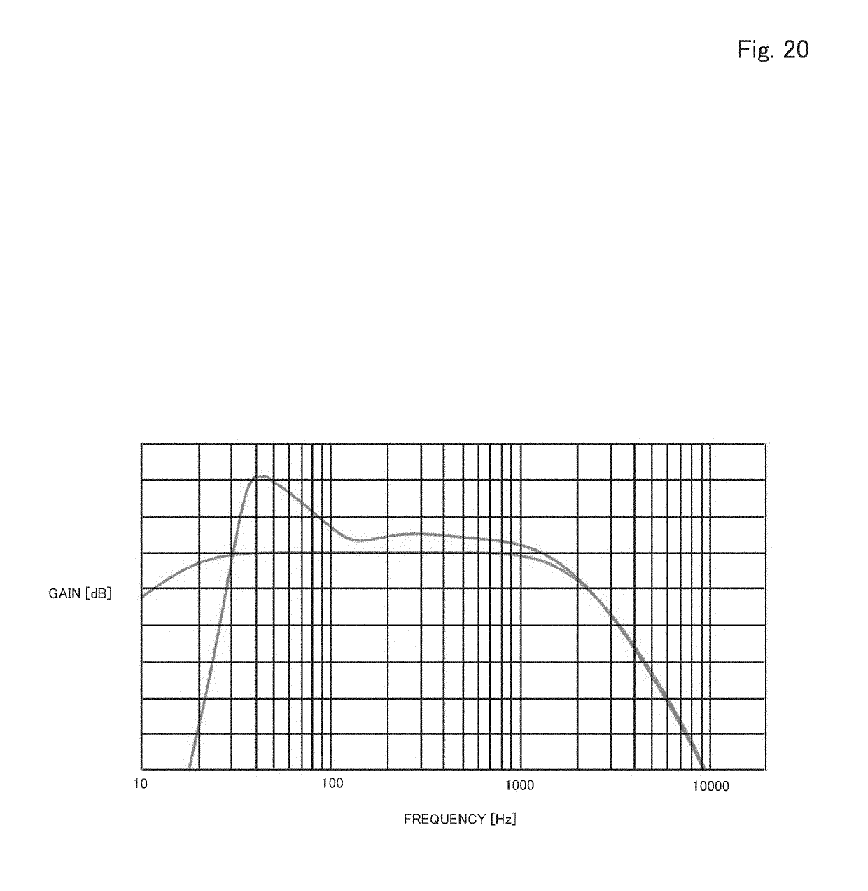

### DETAILED DESCRIPTION OF THE PREFERRED EMBODIMENTS

An objective of the present invention is to resolve volume shortage of the middle and high band of speaker reproduction sound.

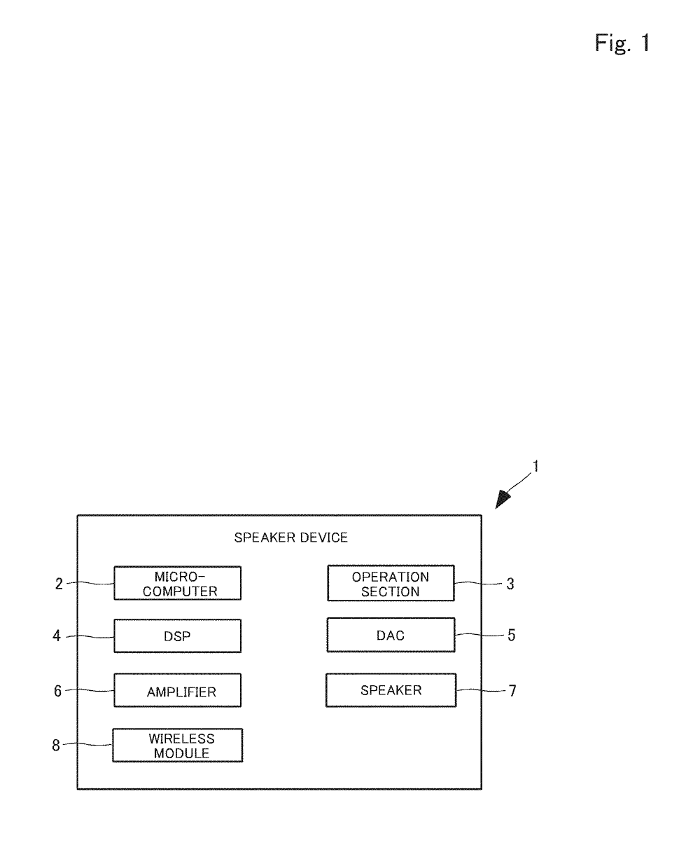

An embodiment of the present invention is described below. FIG. 1 is a diagram illustrating a speaker device according to an embodiment of the present invention. The speaker device 1 includes a microcomputer 2, an operation section 3, a DSP (Digital Signal Processor) 4, a D/A converter (hereinafter, referred as to “DAC”) 5, an amplifier 6, a speaker 7, and a wireless module 8.

The microcomputer 2 controls respective sections composing the speaker device 1. The operation section 3 has operation keys and the like for receiving various settings. For example, the operation section 3 has a volume knob for receiving volume adjustment by a user. The DSP 4 (signal processing device) performs signal processing to a digital audio signal. Signal processing that the DSP 4 performs will be described later. The DAC 5 D/A-converts the digital audio signal to which the DSP 4 performs signal processing into an analog audio signal. The amplifier 6 amplifies the analog audio signal D/A-converted by the DAC 5. The analog audio signal that the amplifier 6 amplifies is output to the speaker 7. The speaker 7 outputs an audio based on the analog audio signal that is input. The wireless module 8 is for performing wireless communication according to Bluetooth (registered trademark) standard and Wi-Fi standard.

For example, the microcomputer 2 receives the digital audio signal that is sent from a smart phone, a digital audio player or the like via the wireless module 10. The microcomputer 2 makes the DSP 4 perform signal processing to the received digital audio signal.

### First Embodiment

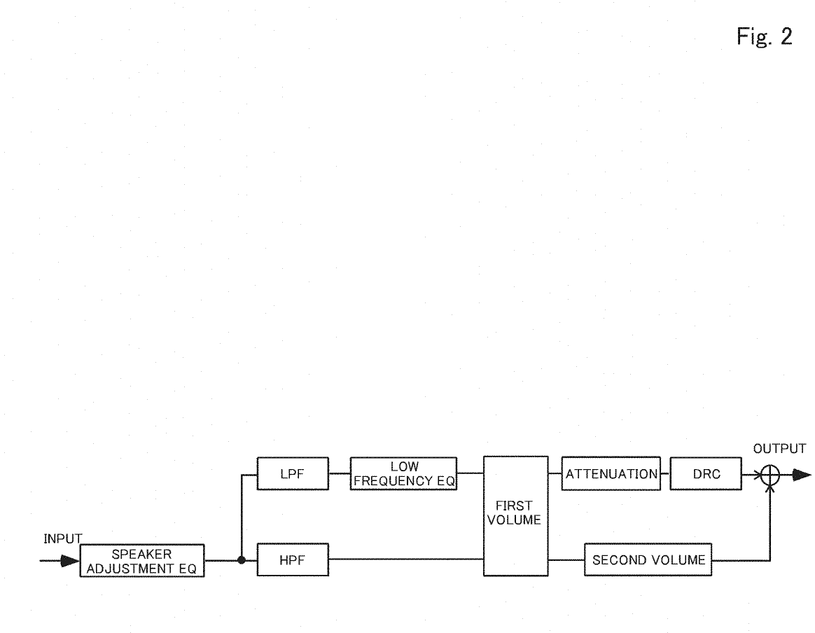

FIG. 2 is a diagram illustrating signal processing by the DSP in a first embodiment. The DSP 4 performs speaker adjustment equalizing processing (hereinafter referred as to “speaker adjustment EQ processing”), low pass filter processing (hereinafter referred as to “LPF processing”), low frequency equalizing processing (hereinafter referred as to “low frequency EQ processing”), attenuation processing, dynamic range control processing (hereinafter referred as to “DRC processing”), high pass filter processing (hereinafter referred as to “HPF processing”), first volume processing, second volume processing, and synthesis processing.

The speaker adjustment EQ processing is processing to adjust frequency characteristics of an audio signal based on characteristics of a speaker. The DSP 4 performs the speaker adjustment EQ processing to the audio signal to be input. The LPF processing is processing to extract the low frequency component (for example, not more than 150 Hz) of the audio signal. The DSP 4 performs the LPF processing to the audio signal to which the speaker adjustment EQ processing is performed. The HPF processing is processing to extract high frequency component (for example, not less than 150 Hz) of the audio signal. The DSP 4 performs the HPF processing to the audio signal to which the speaker adjustment EQ processing is performed. The low frequency EQ processing is processing to boost the low frequency component of the audio signal. The DSP 4 performs the low frequency EQ processing to the audio signal to which the LPF processing is performed.

The attenuation processing is processing to attenuate the audio signal. The DSP 4 performs the attenuation processing to the audio signal to which the first volume processing is performed. The DRC processing (compression processing) is processing to compress the audio signal when the audio signal is not less than a predetermined signal level. The DSP 4 performs the DRC processing to which the low frequency EQ processing is performed.

The second volume processing is processing to attenuate the audio signal based on a volume value that is received by the microcomputer 2. The DSP 4 performs the second volume processing to the audio signal to which the HPF processing is performed. The synthesis processing is processing to synthesize the audio signal to which the DRC processing is performed and the audio signal to which the second volume processing is performed. The DSP 4 performs the synthesis processing to the audio signal to which the DRC processing is performed and the audio signal to which the second volume processing is performed.

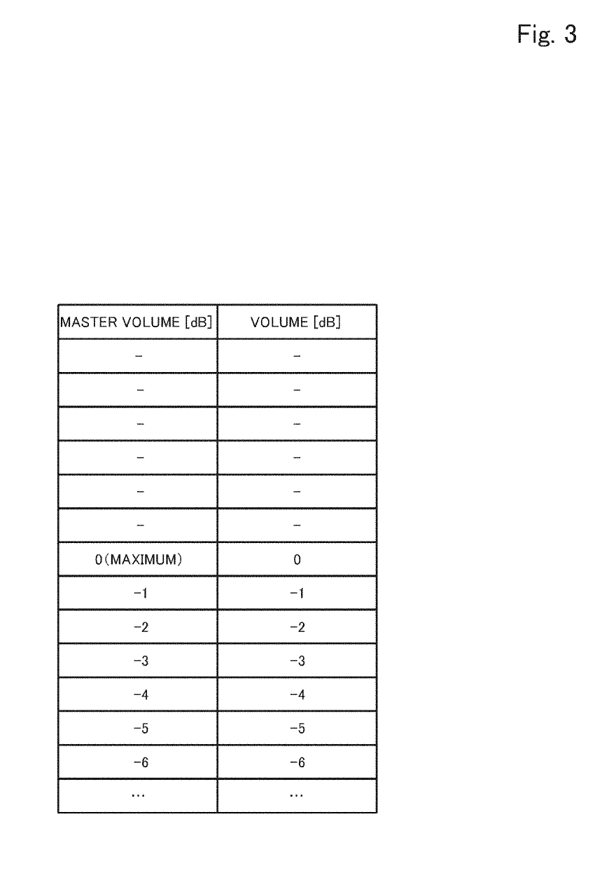

FIG. 3 is a diagram illustrating conventional volume processing that is one volume processing. In the volume processing, all the band of an audio signal is attenuated. In the conventional processing, volume sense of the middle and high frequency is insufficient because volume processing to attenuate the all band component of the audio signal is one.

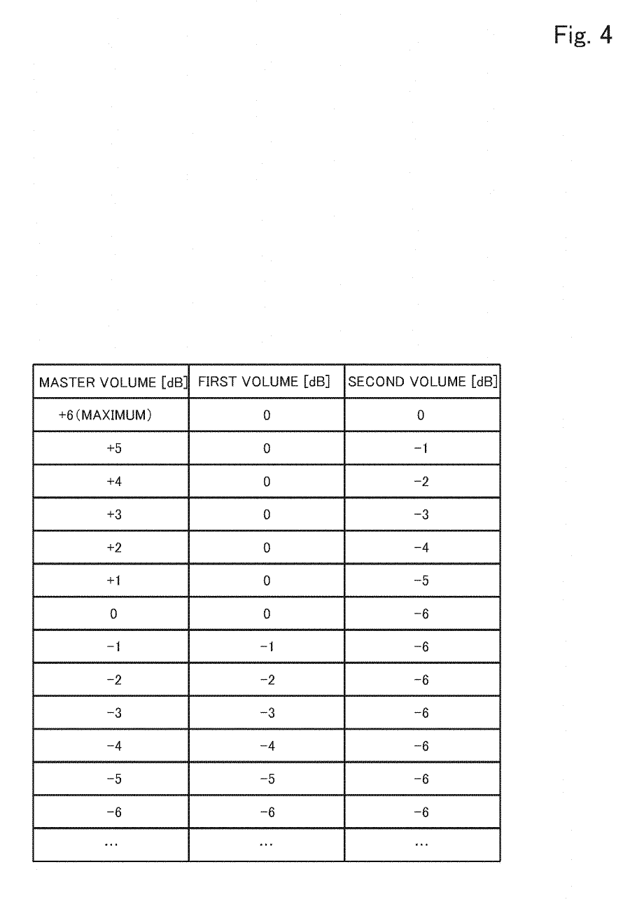

FIG. 4 is a diagram illustrating relationship between the first volume processing and the second volume processing. “Master volume” is a volume value that the microcomputer 2 receives. “First volume” is the attenuation amount by the first volume processing. “Second volume” is the attenuation amount by the second volume processing. In a case that “master volume” is not more than “0 dB” (a predetermined value), the attenuation amount by the second volume processing is constant “−6 dB”. In a case that “master volume” is not more than “0 dB”, the attenuation amount by the first volume processing changes. In a case that “master volume” exceeds “0 dB”, the attenuation is not performed by the first volume processing (attenuation amount 0). In a case that “master volume” exceeds “0 dB”, the attenuation amount by the second volume processing changes. In the present embodiment, even if the attenuation amount by the first volume processing becomes “0 dB”, volume of the middle and high frequency component of the audio signal can be risen (the attenuation amount is decreased) by the second volume processing.

Further, up to now, to perform the low frequency EQ processing, all the band of the audio signal is attenuated. Like the present embodiment, the attenuation processing is performed to only the low frequency component of the audio signal, a predetermined the attenuation amount margin exists in the middle and high frequency of the audio signal compared with a conventional device. Therefore, volume can be raised with the predetermined the attenuation amount in the second volume processing. Further, it is preferable that the attenuation amount by the attenuation processing is a value of difference of the attenuation amount “0 dB” by the first volume processing and the attenuation amount “−6 dB” by the second volume processing in case where “master volume” is “0 dB”. In a case that “master volume” changes beyond “0 dB”, audio that the low frequency component and the middle and high frequency is balanced can be reproduced.

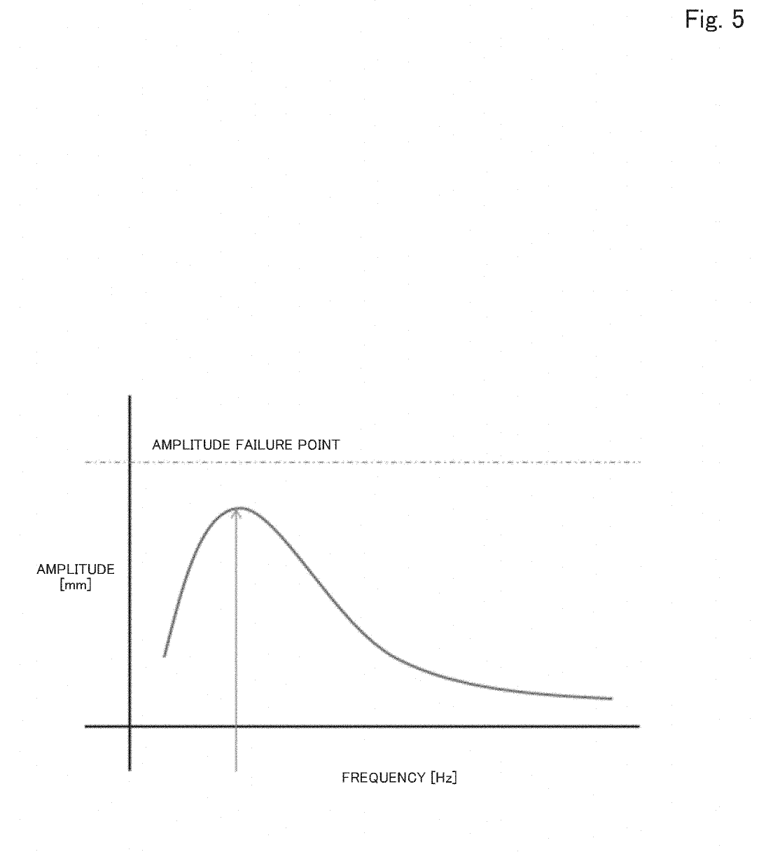

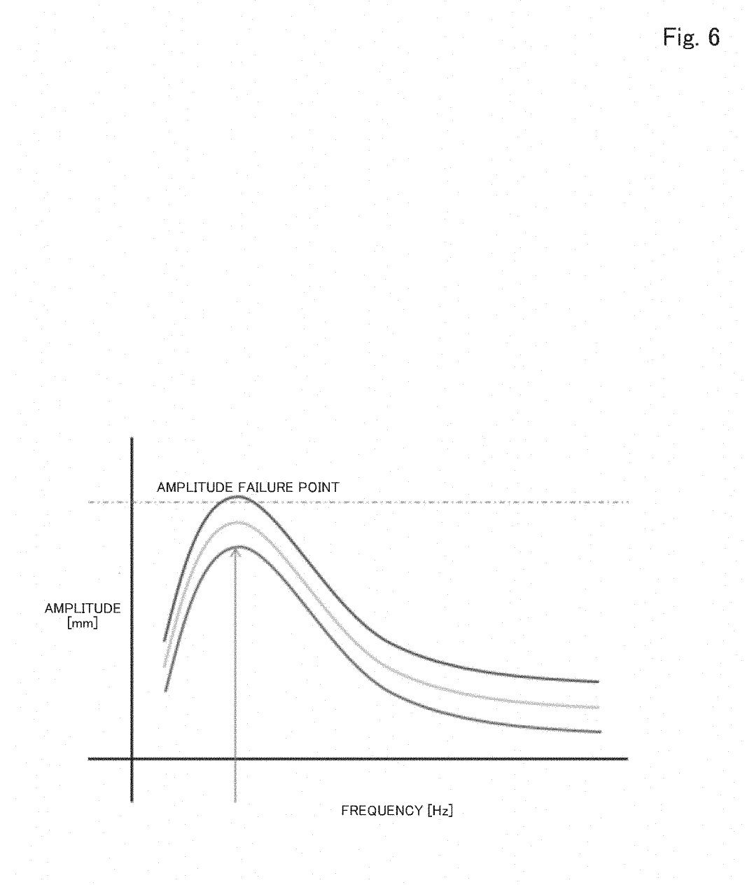

FIG. 5 is a diagram illustrating amplitude of a speaker diaphragm against frequency of the audio signal to which the low frequency EQ processing is performed. As illustrated in FIG. 5, in the low frequency EQ processing, the low frequency component of the audio signal is boosted with a predetermined frequency as a boost point. FIG. 6 is a diagram illustrating a state that volume is raised from the state of FIG. 5. As illustrated in FIG. 6, when volume is raised, the low frequency component of the audio signal reaches amplitude that failure sound outputs and distortion increases greatly.

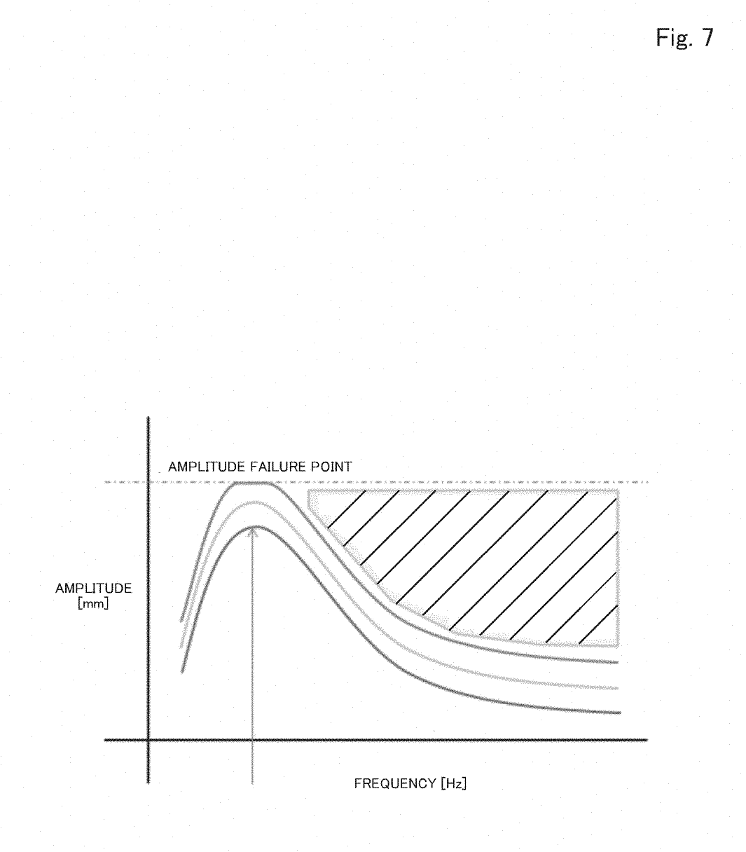

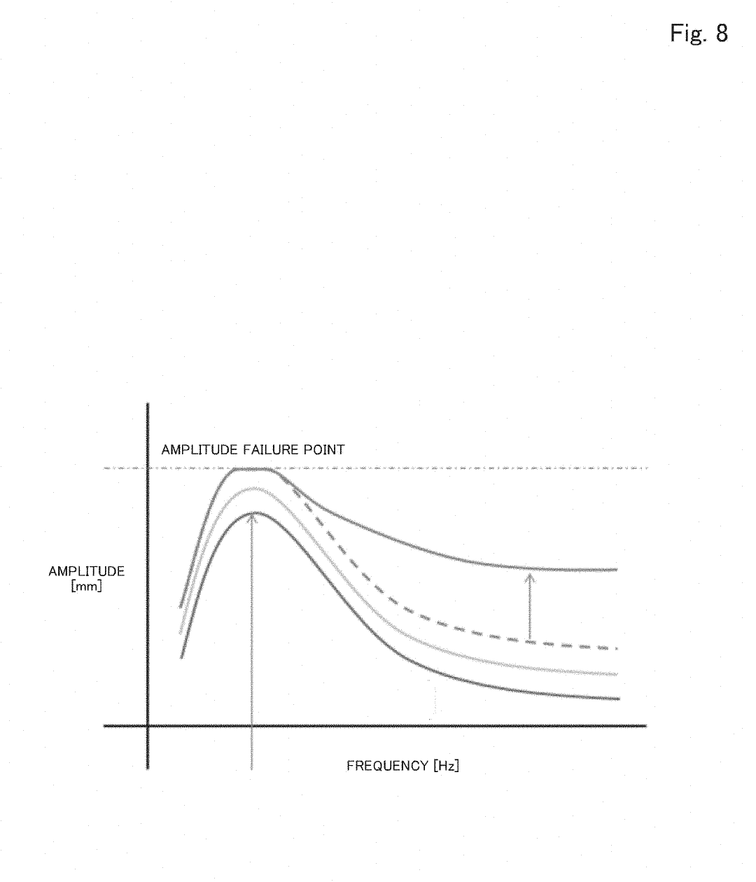

FIG. 7 is a diagram illustrating an audio signal to which the DRC processing is performed. As illustrated in FIG. 7, failure is prevented because the low frequency component of the audio signal is compressed by the DRC processing. However, at a point that the low frequency component becomes 0 dBFS, amplitude of the middle and high frequency (shaded area in FIG. 7) is small and volume is insufficient. In other words, in the middle and high frequency, despite being able to produce volume, it is limited. FIG. 8 is a diagram illustrating addition of volume by the second volume processing. As illustrated in FIG. 8, volume of the middle and high frequency component can be increased by the second volume processing.

### Variation 1 of First Embodiment

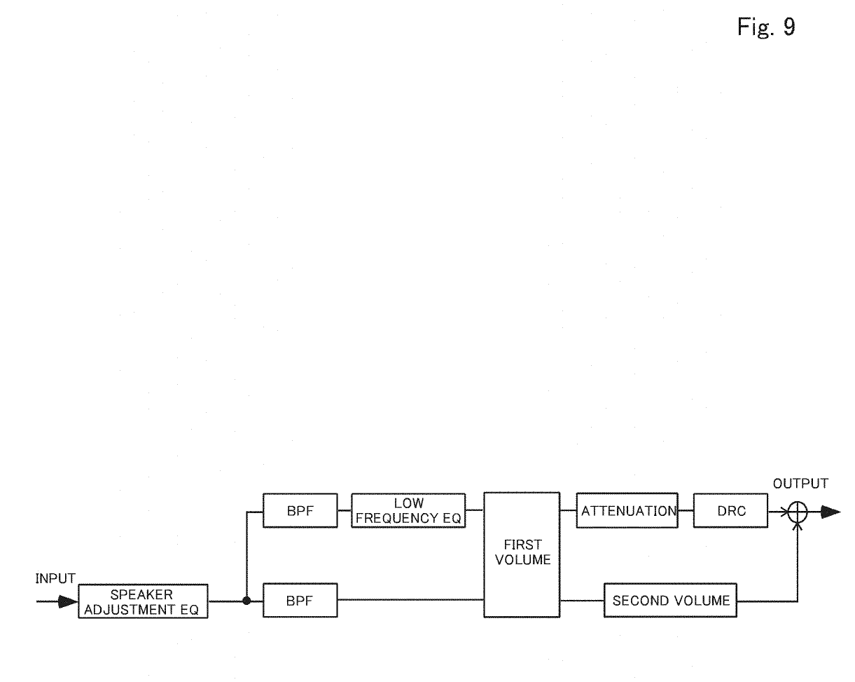

FIG. 9 is a diagram illustrating signal processing by the DSP 4 in a variation 1 of the first embodiment. In the variation 1, the LPF processing is replaced to band bass filter processing (hereinafter, referred as to “BPF processing”) to extract a predetermined frequency band component of the audio signal. Further, the HPF processing is replaced to the BPF processing to extract a predetermined frequency band component of the audio signal.

### Variation 2 of First Embodiment

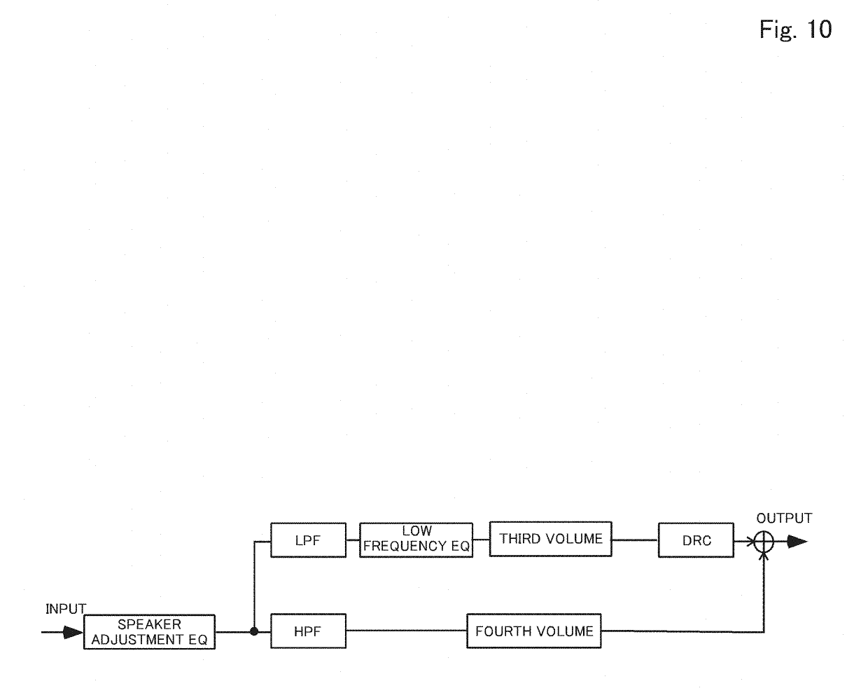

FIG. 10 is a diagram illustrating signal processing by the DSP 4 in a variation 2 of the first embodiment. In the variation 2, the DSP 4 performs third volume processing to attenuate the low frequency component of the audio signal based on a volume value that is received. The DSP 4 performs fourth volume processing to attenuate the high frequency component of the audio signal based on the volume value that is received. Namely, each of volume processing of the low frequency component of the audio signal and volume processing of the high frequency component of the audio signal is independent. In the third volume processing, the attenuation amount of the attenuation processing in the first embodiment may be always added to the attenuation amount by the volume value.

As described above, in the present embodiment, the DSP 4 performs the DRC processing to compress the audio signal to which the LPF processing is performed when the audio signal to which the LPF processing is performed is not less than the predetermined signal level. Thus, volume shortage of the middle and high band can be resolved because the middle and high frequency component of the audio signal is not compressed wastefully.

The low frequency component of the audio signal is compressed at a predetermined signal level or more so that the amplitude of a speaker diaphragm does not reach failure point. However, the middle and high frequency component of the audio signal is not a signal level to reach failure point even if the attenuation amount by the first volume processing to attenuate the all band component of the audio signal based on the volume value that is received is zero. In the present embodiment, the DSP 4 performs the second volume processing to attenuate the audio signal to which the HPF processing is performed based on the volume value that is received. Therefore, volume shortage of the middle and high frequency can be resolved because volume of the middle and high frequency component of the audio signal can be risen (the attenuation amount can be decreased).

Further, in the present embodiment, the attenuation amount by the first volume processing is zero and the attenuation amount by the second volume processing changes in a case that the volume value that is received exceeds a predetermined value. Therefore, the middle and high frequency component of the audio signal can be risen (the attenuation amount can be decreased) by the second volume processing even if the attenuation amount by the first volume processing becomes zero.

In the present embodiment, the DSP 4 performs the first volume to the audio signal to which the low frequency EQ processing is performed and the audio signal to which the HPF processing is performed. However, the first volume processing may be performed before and after any processing as long as it is performed before the DRC processing. For example, in the first embodiment, the DSP 4 may perform the first volume processing to the audio signal before performing the LPF processing and the HPF processing. In the variation 1, the DSP 4 may perform the first volume processing to the audio signal before performing the BPF processing. Further, order of each processing may be interchanged.

Further, in the present embodiment, in the attenuation processing, the constant attenuation amount is attenuated. The variable attenuation amount may be attenuated based on the volume value that is received by the microcomputer 2. In the second volume processing, the audio signal is attenuated (the attenuation amount is variable) based on the volume value that is received by the microcomputer 2. The constant attenuation amount may be attenuated.

### Second Embodiment

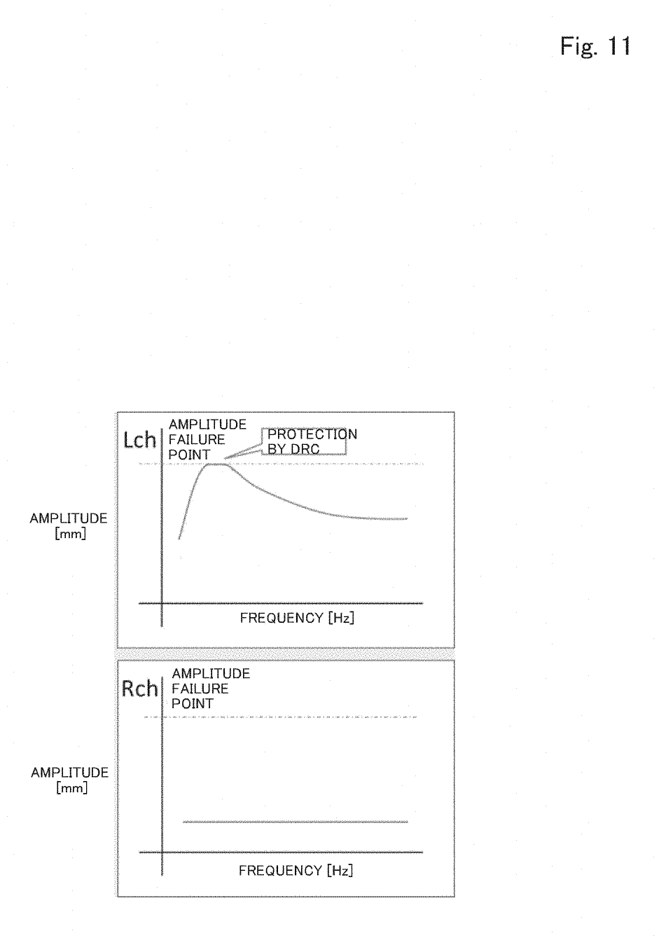

In audio signal processing, a low frequency is enhanced effectively, and in a small type powered speaker which is unsuitable to reproduce low frequency, sound quality improvement can be expected. However, in the first embodiment, there is a problem that volume of bass is likely to be restricted especially and volume sense is insufficient at large volume by enhancing low frequency and performing DRC processing. In FIG. 11, for example, when the level of the left audio signal is large, the low frequency component of the left audio signal (L ch) is only limited, and volume sense of the low frequency is insufficient.

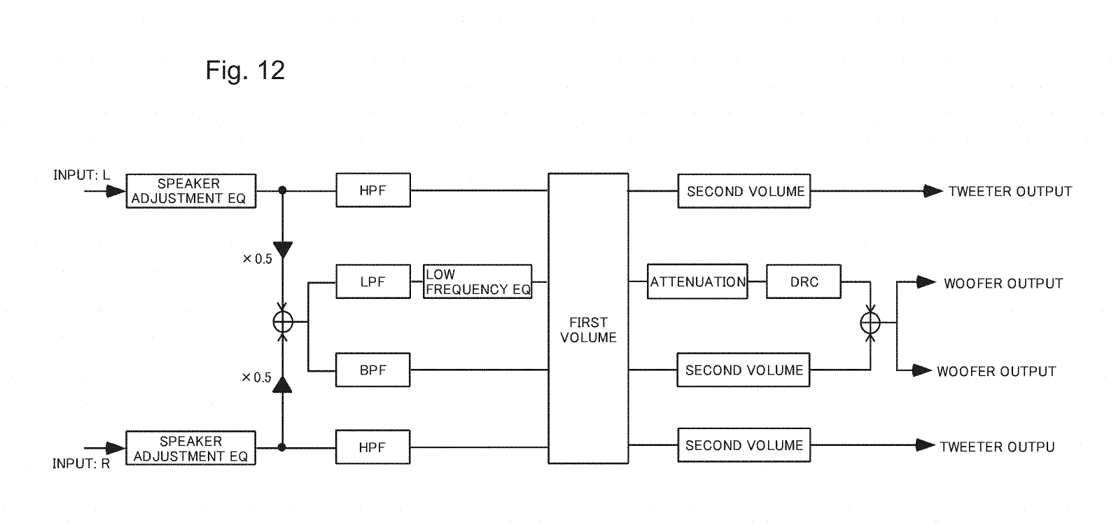

In the second embodiment, the speaker 7 is a 2 way speaker including two tweeters and two woofers. FIG. 12 is a diagram illustrating signal processing by the DSP 4 in the second embodiment. As illustrated in FIG. 12, the DSP 4 performs the speaker adjustment EQ processing, the HPF processing, monaural synthesis processing, the BPF processing, the LPF processing, the low frequency EQ processing, the first volume processing, the attenuation processing, the second volume processing, the DRC processing, and the synthesis processing. The DSP 4 performs signal processing to the left and right audio signals. Description is omitted with regard to the same processing as the first embodiment.

The DSP 4 performs the speaker adjustment EQ processing to the left and right audio signals. The monaural synthesis processing is processing to synthesize the audio signal that the left audio signal is multiplied by 0.5 and the audio signal that the right audio signal is multiplied by 0.5. The DSP 4 performs the monaural synthesis processing to the left and right audio signals to which the speaker EQ adjustment processing is performed. The DSP 4 performs the LPF processing to the audio signal to which the monaural synthesis processing is performed. In the second embodiment, the DSP 4 extracts the low frequency component not more than 100 Hz of the audio signal. The DSP 4 performs the low frequency EQ processing to the audio signal to which the LPF processing is performed.

The DSP 4 performs the BPF processing to the audio signal to which the monaural synthesis processing is performed. In the second embodiment, for example, the DSP 4 extracts a frequency band component between not less than 100 Hz and not more than 300 Hz of the audio signal. The DSP 4 performs the first volume processing to the low frequency component of the monaural audio signal to which the low frequency EQ processing is performed, a predetermined frequency band component of the monaural audio signal to which the BPF processing is performed, and the high frequency component of the left and right audio signals to which the HPF processing is performed. Therefore, the first volume processing is performed to the all band component of the audio signal which is output to the speaker 7.

The DSP 4 performs the second volume processing to the high frequency component of the left and right audio signals to which the first volume processing is performed. The DSP 4 performs the attenuation processing to the low frequency component of the monaural audio signal to which the first volume processing is performed. The DSP 4 performs the DRC processing to the low frequency component of the monaural audio signal to which the attenuation processing is performed. The DSP 4 performs the second volume processing to the predetermined frequency band component of the monaural audio signal to which the first volume processing is performed. In the synthesis processing, the DSP 4 synthesizes the low frequency component of the monaural audio signal to which the DRC processing is performed and the predetermined frequency band component of the monaural audio signal to which the second volume processing is performed. The high frequency component of the left and right audio signals to which the second volume processing is performed is output to the tweeters respectively. The band component not more than the predetermined frequency of the monaural audio signal that the synthesis processing is performed is output to two woofers.

As described above, in the present embodiment, the DSP 4 performs the BPF processing and the LPF processing to the audio signal obtained by synthesizing the audio signal that the left audio signal is multiplied by 0.5 and the audio signal that the right audio signal that is multiplied by 0.5. Namely, the band component not more than the predetermined frequency of the monauralized audio signal is extracted. Further, the DRC processing is performed to the low frequency component of the monaural audio signal to which the LPF processing is performed. Thus, volume shortage of bass and margin shortage of input signal level of the DRC processing for one speaker can be resolved.

Two examples in case where the maximum signal level is 100 and a limit signal level of the DRC processing is 50 are described.

### Example 1: Case where One Channel is a Signal Level which is Suppressed by the DRC Processing

According to conventional technology, when level L1 of the left audio signal is 80, and level R1 of the right audio signal is 20, the level L2 of the left audio signal becomes 50, and the level R2 of the right audio signal becomes 20 by the DRC processing. Therefore, all the output signal level of bass=L2+R2 becomes 70, the signal level at which 100 should be output is lost originally. In contrast to this, in the present embodiment, the DRC processing works on an average value of the left and right audio signal level. For this reason, when the level L1 of the left audio signal is 80, and the level R1 of the right audio signal is 20, average value of the left and right audio signal level is taken by the monaural synthesis processing. Signal level before input to the DRC processing becomes to L2, R2=(L1*0.5)+(R1*0.5), namely, the level L2 of the left audio signal=50 and the level R2 of the right audio signal=50. Therefore, even if each signal passes through the DRC processing, all the output signal level of bass becomes L2+R2=100. Reproduction can be performed without impairing original signal level.

### Example 2: Case where One Signal Level is a Level which Reaches to Limit of the DRC Processing

In the present embodiment, when the level L1 of the left audio signal is 50, and the level R1 of the right audio signal is 0, the average value of the left and right audio signal level is taken by the monaural synthesis processing. Signal level before input to the DRC processing becomes the level L2 of the left audio signal=25 and the level R2 of the right audio signal=25. Therefore, all the output signal level of bass=L2+R2=50 does not changes. Margin can be made for limit value 50 of the DRC processing for one speaker. Effect of spreading burden on a speaker unit and an amplifier can be obtained.

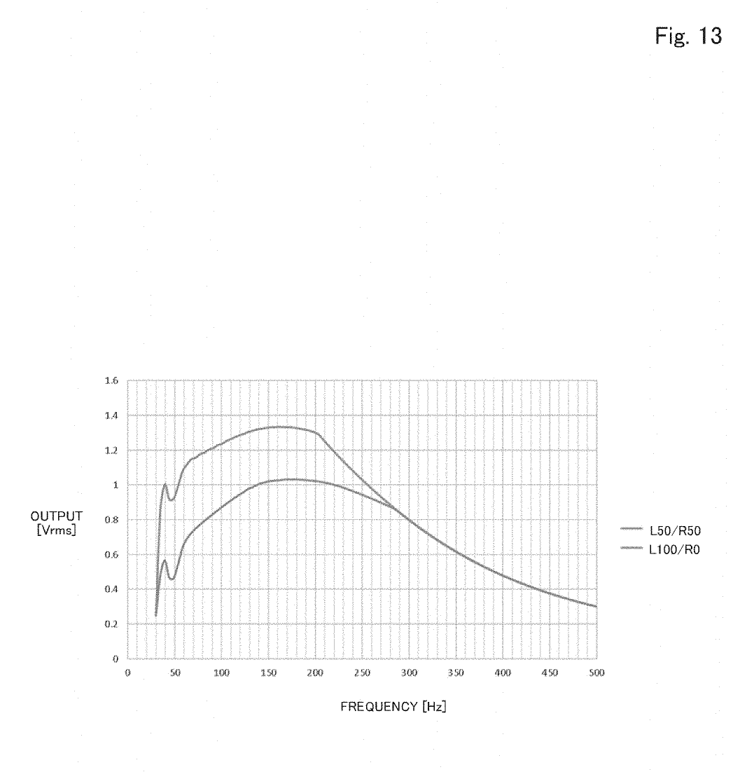

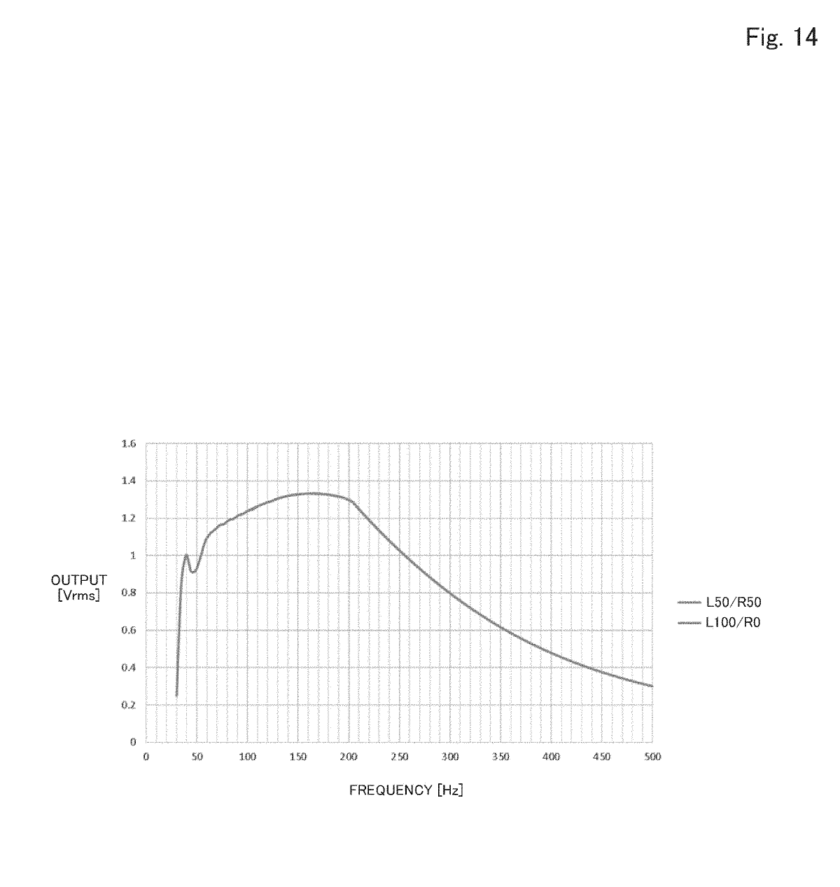

FIG. 13 is a graph illustrating the signal level in the first embodiment. FIG. 14 is a graph illustrating the signal level in the present embodiment. Horizontal axis illustrates frequency. Vertical axis illustrates output from the DAC. Case where the level L1 of the left audio signal is 50 and the level R1 of the right audio signal is 50 and case where the level L1 of the left audio signal is 100 and the level R1 of the right audio signal is 100 are illustrated. As illustrated in the figure, it is understood that reproduction is performed without losing signal level of bass.

In the present embodiment, the DSP 4 performs the first volume processing to the audio signal to which the low frequency EQ processing is performed, the audio signal to which the BPF processing is performed, and the audio signal to which the HPF processing is performed. The first volume processing may be performed before or after any processing as long as the first volume processing is performed before the DRC processing. For example, in the second embodiment, the DSP 4 may perform the first volume processing to the audio signal before performing the monaural synthesis processing and the HPF processing. Further, order of each processing may be interchanged.

Further, in the present embodiment, in the attenuation processing, the constant attenuation amount is attenuated. The variable attenuation amount may be attenuated based on a volume value that is received by the microcomputer 2. In the second volume processing, the audio signal is attenuated (attenuation amount is variable) based on the volume value that is received by the microcomputer 2. The constant attenuation amount may be attenuated.

### Third Embodiment

In the second embodiment, by monaural-synthesizing the left and right audio signals, taking the average value of the left and right audio signals, and reproducing with operating the same multiple speakers (woofers) in parallel, effect to obtain volume sense of bass and disperse load on each speaker unit and amplifier can be expected. However, there is a problem that band (not less than 100 Hz) which does not need monaural synthesis is monauralized and stereo sense is lacked.

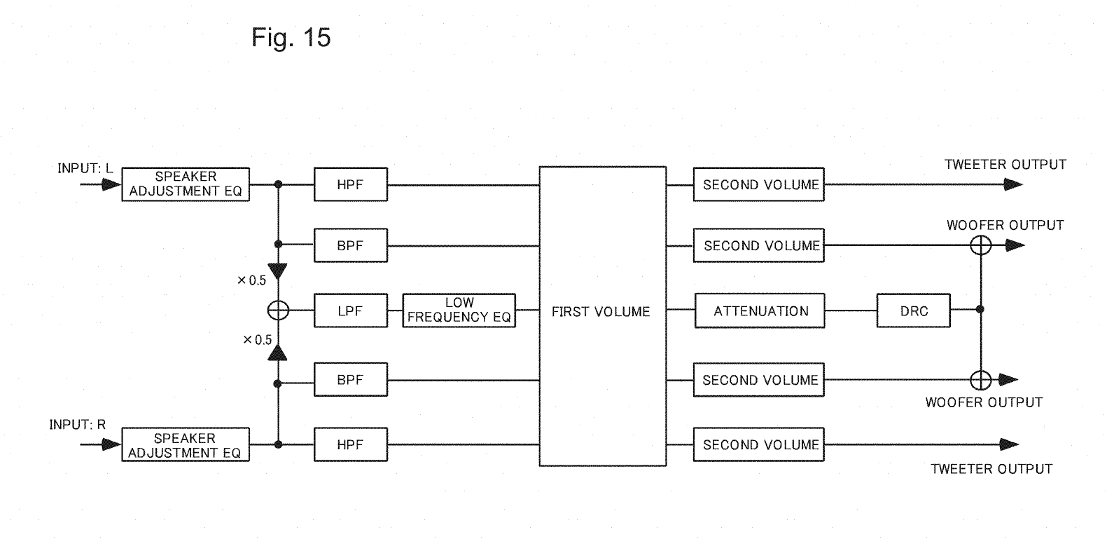

In the third embodiment, the speaker 7 is a 2 way speaker which includes two tweeters and two woofers. FIG. 15 is a diagram illustrating signal processing by the DSP in the third embodiment. As illustrated in FIG. 15, the DSP 4 performs the speaker adjustment EQ processing, the monaural synthesis processing, the LPF processing, the BPF processing, the HPF processing, the first volume processing, the attenuation processing, the low frequency EQ equalizing processing, the DRC processing, the second volume processing, and the synthesis processing. The DSP 4 performs the signal processing to the left and right audio signals. Description is omitted with regard to the same processing as the first and the second embodiment.

The DSP 4 performs the speaker adjustment EQ processing to the left and right audio signals. The DSP 4 performs the HPF processing to the left and right audio signals to which the speaker adjustment EQ processing is performed. In the third embodiment, for example, the DSP 4 extracts a high frequency component not less than 300 Hz of the audio signal. The DSP 4 performs the BPF processing to the left and right audio signals to which the speaker EQ processing is performed. In the present embodiment, for example, the DSP 4 extracts the predetermined frequency band component not less than 100 Hz and not more than 300 Hz.

The DSP 4 performs the monaural synthesis processing to the left and right audio signals to which the speaker adjustment EQ processing is performed. The DSP 4 performs the LPF processing to the monaural audio signal to which the monaural synthesis processing is performed. In the third embodiment, for example, the DSP 4 extracts the low frequency component not more than 100 Hz. The DSP 4 performs the low frequency EQ processing to the low frequency component of the monaural audio signal to which the LPF processing is performed. The DSP 4 performs the first volume processing to the high frequency component of the left and right audio signals to which the HPF processing is performed, the predetermined frequency band component of the left and right audio signals to which the BPF processing is performed, and the low frequency component of the monaural audio signal to which the low frequency EQ processing is performed.

The DSP 4 performs the second volume processing to the high frequency component of the left and right audio signals and the predetermined frequency band component of the left and right audio signals to which the first volume processing is performed. The left and right audio signals to which the second volume processing is performed are output to the tweeters respectively. The DSP 4 performs the attenuation processing to the low frequency component of the monaural processing to which the first volume processing is performed. The DSP 4 performs the DRC processing to the low frequency component of the monaural audio signal to which the attenuation processing is performed. In the synthesis processing, the DSP 4 synthesizes the predetermined frequency band component of the left audio signal to which the second volume processing is performed and the low frequency component of the monaural audio signal to which the DRC processing is performed, and synthesizes the low frequency component of the monaural audio signal to which the DRC processing is performed and the predetermined frequency band component of the right audio signal to which the second volume processing is performed. The audio signal to which the synthesis processing is performed is output to two woofers.

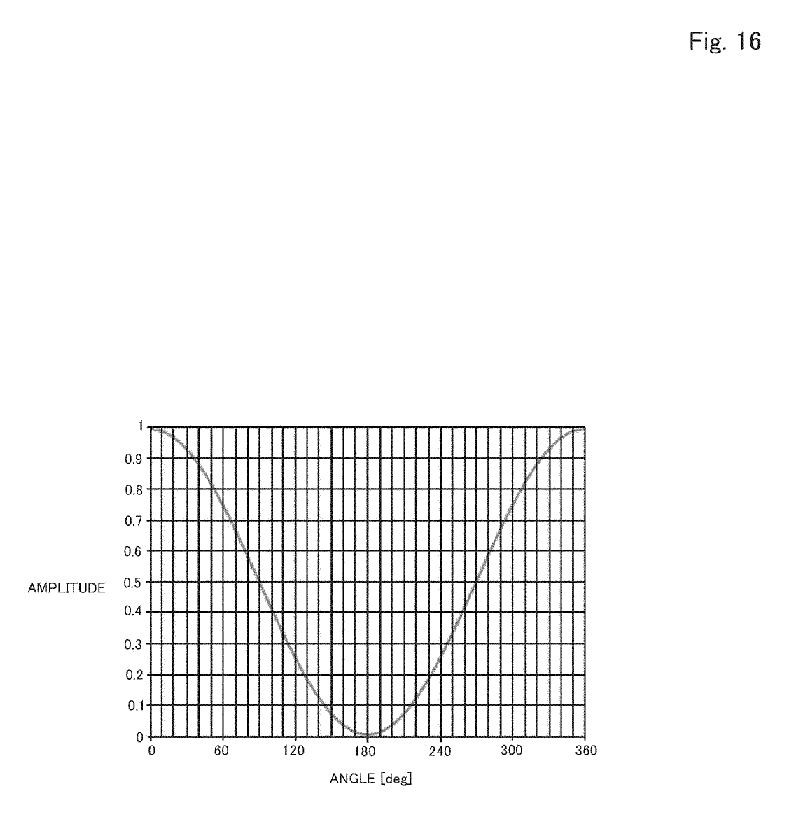

FIG. 16 is a graph illustrating the audio signal to which the monaural synthesis processing is performed. A vertical axis illustrates amplitude, and a horizontal axis illustrates angle. As described above, the monaural synthesis processing is processing in which the audio signal (L/2) that the left audio signal is multiplied by 0.5 and the audio signal (R/2) that the right audio signal to which the first volume processing is performed is multiplied by 0.5 (L/2+R/2). As illustrated in FIG. 16, the more the phase of L/R deviates, the lower the signal level becomes. Reverse phase component vanishes completely. In a one box speaker, there is little harm of monaural-synthesizing in advance because the low frequency component of reverse phase vanishes based on length of wavelength by spatial synthesis. For this reason, the signal not more than 100 Hz is monaural-synthesized positively, and volume sense of the low frequency is obtained. Meanwhile, by leaving the left and right (stereo) signals, stereo sense is obtained in a band which is covered by the same unit because harm caused by cancellation of reverse phase component is strong. Like this, compatibility of volume sense and stereo sense can be achieved at the same time.

As described above, the DSP 4 performs the LPF processing to the audio signal that synthesizes the left audio signal that is multiplied by 0.5 and the right audio signal that is multiplied by 0.5. Namely, the low frequency component of the monauralized audio signal is extracted. Further, the DSP 4 synthesizes the low frequency component of the audio signal and the predetermined frequency band component of the left audio signal, and synthesizes the low frequency component of the audio signal and the predetermined frequency band component of the right audio signal. Therefore, the synthesized audio signal is output to two woofers, the high frequency component of the left and right audio signals is output to two tweeters, and the audio signal not less than the predetermined frequency is still stereo, and the audio signal not more than the predetermined frequency is monauralized. For this reason, volume sense of bass can be secured. Further, burden of each unit/amplifier can be spread, and stereo sense can be obtained. Like this, according to the present embodiment, volume sense and stereo sense can be compatible.

In the present embodiment, the DSP 4 performs the first volume processing to the audio signal to which the low frequency EQ processing is performed, the audio signal to which the BPF processing is performed, and the audio signal to which the HPF processing is performed. The first volume processing may be performed before or after any processing as long as the first volume processing is performed before the DRC processing. For example, in the third embodiment, the DSP 4 may perform the first volume processing to the audio signal before performing the monaural synthesis processing, the BPF processing, and the HPF processing. Further, order of each processing may be interchanged.

Further, in the present embodiment, in the attenuation processing, the constant attenuation amount is attenuated. The variable attenuation amount may be attenuated based volume value that is received by the microcomputer 2. In the second volume processing, the audio signal is attenuated (attenuation amount is variable) based on a volume value that is received by the microcomputer 2. The constant attenuation amount may be attenuated.

### Fourth Embodiment

In the second embodiment, as described above, there is a problem that stereo sense is lacked.

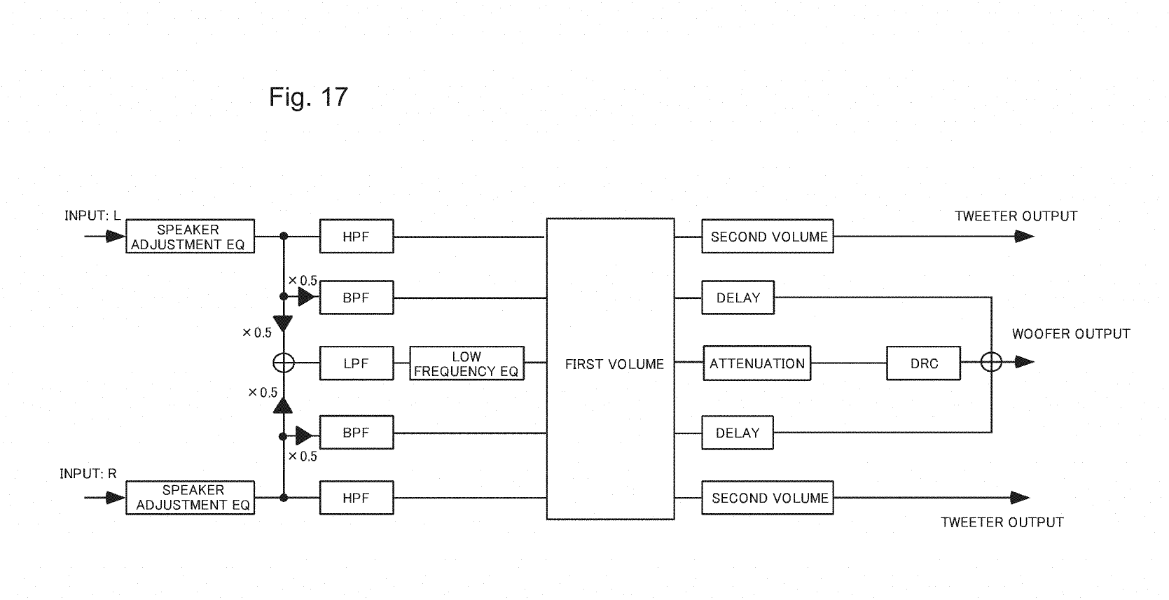

In the fourth embodiment, the speaker 7 is a 2 way speaker which includes two tweeters and one woofer. FIG. 17 is a diagram illustrating signal processing by the DSP 4 in the fourth embodiment. As illustrated in FIG. 17, the DSP 4 performs the speaker adjustment EQ processing, the monaural synthesis processing, the LPF processing, the BPF processing, the HPF processing, the first volume processing, the attenuation processing, the low frequency EQ processing, the DRC processing, the second volume processing, delay processing, and the synthesis processing. The DSP 4 performs the signal processing to the left and right audio signals. Description is omitted with regard to the same processing as the first to the third embodiment.

The DSP 4 performs the speaker adjustment EQ processing to the left and right audio signals. The DSP 4 performs the HPF processing to the left and right audio signals to which the speaker adjustment EQ processing is performed. In the fourth embodiment, for example, the DSP 4 extracts the high frequency component not less than 300 Hz of the audio signal. The DSP 4 performs the BPF processing to the audio signal that the left audio signal to which the speaker adjustment EQ processing is performed is multiplied by 0.5. The DSP 4 performs the BPF processing to the audio signal that the right audio signal to which the speaker adjustment EQ processing is performed is multiplied by −0.5. In the fourth embodiment, for example, the DSP 4 extracts the high frequency not more than 100 Hz and not less than 300 Hz.

The DSP 4 performs the monaural synthesis processing to the left and right audio signals to which the speaker adjustment EQ processing is performed. The DSP 4 performs the LPF processing to the monaural audio signal to which the monaural synthesis processing is performed. In the fourth embodiment, for example, the DSP 4 extracts the low frequency component not more than 100 Hz. The DSP 4 performs the low frequency EQ processing to the low frequency component of the monaural audio signal to which the LPF processing is performed. The DSP 4 performs the first volume processing to the high frequency component of the left and right audio signals to which the HPF processing is performed, the predetermined frequency band component of the left and right audio signals to which the BPF processing is performed, and the low frequency component of the monaural audio signal to which the low frequency EQ processing is performed.

The DSP 4 performs the second volume processing to the left and right audio signals to which the first volume processing is performed. The left and right audio signals to which the second volume processing is performed are output to the tweeters respectively. The DSP 4 performs the attenuation processing to the low frequency component of the monaural audio signal to which the first volume processing is performed. The DSP 4 performs the DRC processing to the low frequency component of the monaural audio signal to which the attenuation processing is performed. The DSP 4 performs the delay processing to delay the predetermined frequency band component of the left and right audio signals to which the second volume processing is performed. In the synthesis processing, the DSP 4 synthesizes the predetermined frequency band component of the left and right audio signals to which the delay processing is performed and the low frequency component of the monaural audio signal to which the DRC processing is performed. The audio signal to which the synthesis processing is performed is output to one woofer.

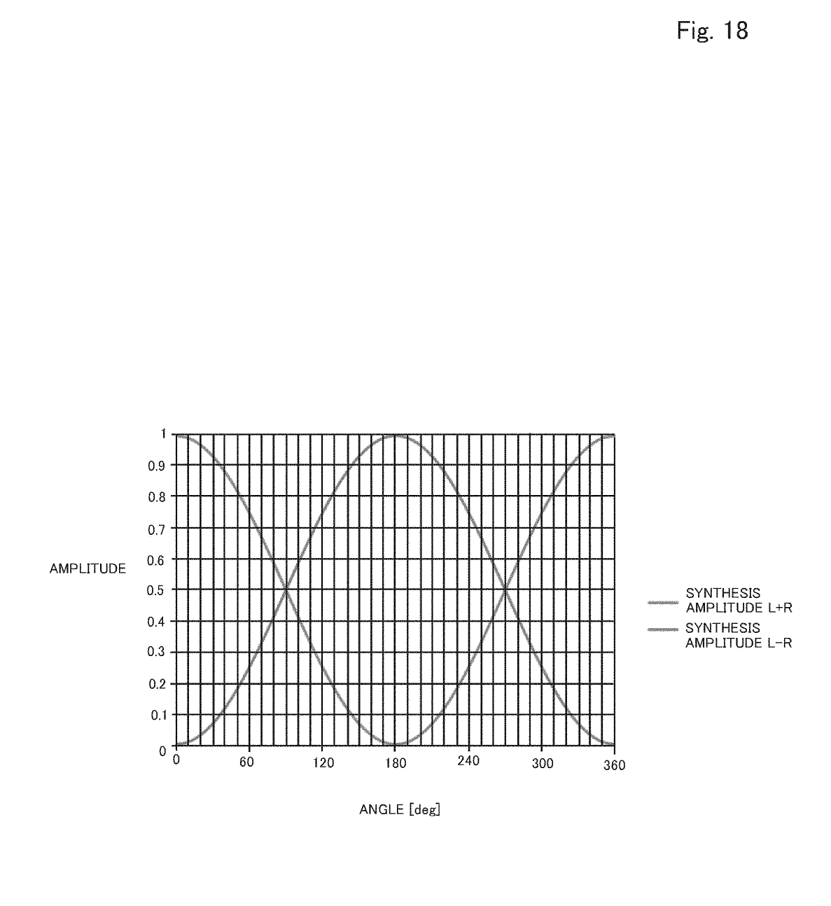

In the monaural synthesis processing, as described above, processing of “L/2+R/2” is performed. For this reason, as illustrated in FIG. 16, the more the phase of L/R deviates, the lower the signal level becomes. Herein, in the present embodiment, the DSP 4 delays the predetermined frequency band component of the audio signal (L/2) that is the left audio signal multiplied by 0.5 and the predetermined frequency band component of the audio signal (−R/2) that is the right audio signal multiplied by −0.5, and adds these signals to the low frequency component of the monaural audio signal (delay processing and synthesis processing). FIG. 18 is a graph that phase−amplitude characteristics of “L/2−R/2” are over-written to FIG. 15. Two signals are added, and it is thought that a problem of lack of stereo sense is resolved. However, component of R only vanishes. For this reason, by delaying reverse phase component, signal of “L/2+R/2” and signal of “L/2−R/2” coexist spuriously, and the lack of stereo sense can be eased.

In the present embodiment, the DSP 4 performs the first volume processing to the audio signal to which the low frequency EQ processing is performed, the audio signal to which the BPF processing is performed, and the audio signal to which the HPF processing is performed. The first volume processing may be performed before or after any processing as long as the first volume processing is performed before the DRC processing. For example, in the fourth embodiment, the DSP 4 may perform the first volume processing to the audio signal before performing the monaural synthesis processing, the BPF processing, and the HPF processing. Further, order of each processing may be interchanged.

Further, in the present embodiment, in the attenuation processing, the constant attenuation amount is attenuated. The variable attenuation amount may be attenuated based on a volume value that is received by the microcomputer 2. In the second volume processing, the audio signal is attenuated (attenuation amount is variable) based on a volume value that is received by the microcomputer 2. The constant attenuation amount may be attenuated.

The embodiments of the present invention are described above, but the mode to which the present invention is applicable is not limited to the above embodiments and can be suitably varied without departing from the scope of the present invention.

In the above described embodiment, each processing such as the first volume processing is performed by the DSP 4. Not limited to this, each processing may be performed by a dedicated circuit or the like. For example, the first volume processing is performed by an SoC (System On Chip) (controller).

The present invention can be suitably employed in a signal processing device that performs signal processing to an audio signal, a signal processing method, and a speaker device that includes the signal processing device.

1. A signal processing device configured to perform:
low pass filter processing to extract a low frequency component of an audio signal,
compression processing to compress the audio signal to which the low pass filter processing is performed in a case that the audio signal to which the low pass filter processing is performed is not less than a predetermined signal level,
high pass filter processing to extract high frequency component of the audio signal,
first volume processing to attenuate the audio signal, and
synthesis processing to synthesize the low frequency component of the audio signal to which the compression processing is performed and high frequency component of the audio signal.

2. The signal processing device according to claim 1,
wherein, in the first volume processing, the audio signal is attenuated based on a volume value that is received.

3. The signal processing device according to claim 1,
wherein, the first volume processing is performed to the audio signal to which the low pass filter processing is performed and the audio signal to which the high pass filter processing is performed.

4. The signal processing device according to claim 1,
wherein, the low pass filter processing and the high pass filter processing are performed to the audio signal to which the first volume processing is performed.

5. The signal processing device according to claim 1, further configured to perform:
monaural synthesis processing to synthesize an audio signal that a left audio signal is multiplied by 0.5 and an audio signal that a right audio signal is multiplied by 0.5, and
band pass filter processing to extract a predetermined frequency band component between the low frequency component and the high frequency component of the audio signal to which the monaural synthesis processing is performed,
wherein, in the low pass filter processing, the low frequency component of the audio signal to which the monaural synthesis processing is performed is extracted,
in the compression processing, the audio signal to which the low pass filter processing is performed is compressed when the audio signal to which the low pass filter processing is not less than the predetermined signal level,
in the high pass filter processing, the high frequency component of the left and right audio signals is extracted,
in the first volume processing, the left and right audio signals are attenuated, and
in the synthesis processing, the low frequency component of the audio signal to which the compression processing is performed and a predetermined frequency band component of the audio signal are synthesized.

6. The signal processing device according to claim 5,
wherein, the first volume processing is performed to the audio signal to which the low pass filter processing is performed, the audio signal to which the band pass filter processing is performed, and the audio signal to which the high pass filter processing is performed.

7. The signal processing device according to claim 5,
wherein, the high pass filter and the monaural synthesis processing are performed to the audio signal to which the first volume processing is performed.

8. The signal processing device according to claim 1, further configured to perform:
band pass filter processing to extract a predetermined frequency band component between the low frequency component and the high frequency component of the left and right audio signals, and
monaural synthesis processing to synthesize the audio signal that a left audio signal is multiplied by 0.5 and the audio signal that a right audio signal is multiplied by 0.5,
wherein, in the low pass filter processing, the low frequency component of the audio signal to which the monaural synthesis processing is performed is extracted,
in the compression processing, the audio signal to which the low pass filter processing is performed when the audio signal to which the low pass filter processing is not less than the predetermined signal level is compressed,
in the high pass filter processing, the high frequency component of the left and right audio signals is extracted,
in the first volume processing, the left and right audio signals are attenuated, and
in the synthesis processing, the low frequency component of the audio signal to which the compression processing is performed and the predetermined frequency band component of the left audio signal are synthesized and the low frequency component of the audio signal to which the compression processing is performed and the predetermined frequency band component of the right audio signal are synthesized.

9. The signal processing device according to claim 8,
wherein, the first volume processing is performed to the audio signal to which the low pass filter processing is performed, the audio signal to which the band pass filter processing is performed, and the audio signal to which the high pass filter processing is performed.

10. The signal processing device according to claim 8,
wherein, the high pass filter processing, the band pass filter processing, and the monaural synthesis processing are performed to the audio signal to which the first volume processing is performed.

11. The signal processing device according to claim 1, further configured to perform
band pass filter processing to extract a predetermined frequency band component between the low frequency component and the high frequency component of the audio signal that a left audio signal is multiplied by 0.5 and extract a predetermined frequency band component of the audio signal that a right audio signal is multiplied by −0.5,
monaural synthesis processing to synthesis the audio signal that the left audio signal is multiplied by 0.5 and the audio signal that the right audio signal is multiplied by 0.5, and
delay processing to delay the left and right audio signals to which the band pass filter processing is performed,
wherein, in the low pass filter processing, the low frequency component the audio signal to which the monaural synthesis processing is performed is extracted,
in the compression processing, the audio signal to which the low pass filter processing is performed when the audio signal to which the low pass filter processing is performed is not less than a predetermined signal level is compressed,
in the high pass filter processing, the high frequency component of the left and right audio signal is extracted,
in the first volume processing, the left and right audio signals are attenuated, and
in the synthesis processing, the low frequency component of the audio signal to which the compression processing is performed and the predetermined frequency band component of the left and right audio signals to which the delay processing is performed are synthesized.

12. The signal processing device according to claim 11,
wherein, the first volume processing is performed to the audio signal to which the low pass filter processing is performed, the audio signal to which the band pass filter processing is performed, and the audio signal to which the high pass filter processing is performed.

13. The signal processing device according to claim 11,
wherein, the high pass filter processing, the band pass filter processing, and the monaural synthesis processing are performed to the audio signal to which the first volume processing is performed.

14. The signal processing device according to claim 5,
wherein, the high frequency component of the left and right audio signals is output to tweeters respectively, and
the audio signal to which the synthesis processing is performed is output to two woofers respectively.

15. The signal processing device according to claim 11,
wherein, the high frequency component of the left and right audio signals is output to tweeters respectively, and
the audio signal to which the synthesis processing is performed is output to one woofer.

16. The signal processing device according to claim 1, further configured to perform second volume processing to attenuate the high frequency component of the audio signal.

17. The signal processing device according to claim 1, further configured to perform second volume processing to attenuate the predetermined frequency band component and the high frequency component of the audio signal.

18. The signal processing device according to claim 16,
wherein, in the second volume processing device, the audio signal is attenuated based on a volume value that is received.

19. The signal processing device according to claim 1, further configured to perform low frequency equalizing processing to boost the low frequency equalizing processing of the audio signal.

20. The signal processing device according to claim 1, further configured to perform attenuation processing to attenuate the low frequency component of the audio signal.

21. The signal processing device according to claim 1,
wherein, instead of the low pass filter processing, to perform first band pass filter to extract a predetermined frequency band component of the audio signal, and
instead of the high pass filter processing, to perform second band pass filter processing to extract a predetermined frequency band component of the audio signal.

22. The signal processing device according to claim 1,
wherein, instead of the first volume processing, to perform third volume processing to attenuate the low frequency component of the audio signal and fourth volume processing to attenuate the high frequency component of the audio signal.

23. A speaker device comprising:
the signal processing device configured to perform:
low pass filter processing to extract a low frequency component of an audio signal,
compression processing to compress the audio signal to which the low pass filter processing is performed in a case that the audio signal to which the low pass filter processing is performed is not less than a predetermined signal level,
high pass filter processing to extract high frequency component of the audio signal,
first volume processing to attenuate the audio signal, and
synthesis processing to synthesize the low frequency component of the audio signal to which the compression processing is performed and high frequency component of the audio signal, and
a speaker to which an audio signal from the signal processing device is input.

24. A signal processing method performing:
low pass filter processing to extract a low frequency component of an audio signal,
compression processing to compress the audio signal to which the low pass filter processing is performed in a case that the audio signal to which the low pass filter processing is performed is not less than a predetermined signal level,
high pass filter processing to extract high frequency component of the audio signal,
first volume processing to attenuate the audio signal, and
synthesis processing to synthesize the low frequency component of the audio signal to which the compression processing is performed and high frequency component the audio signal.

25. The signal processing method according to claim 24 further performing:
monaural synthesis processing to synthesize the audio signal that a left audio signal is multiplied by 0.5 and the audio signal that a right audio signal is multiplied by 0.5, and
band pass filter processing to extract a predetermined frequency band component between the low frequency component and the high frequency component of the audio signal to which the monaural synthesis processing is performed,
wherein, in the low pass filter processing, the low frequency component of the audio signal to which the monaural synthesis processing is performed is extracted,
in the compression processing, the audio signal to which the low pass filter processing is performed is compressed when the audio signal to which the low pass filter processing is performed is not less than the predetermined signal level,
in the high pass filter processing, the high frequency component of the left and right audio signals is extracted,
in the first volume processing, the left and right audio signals are attenuated, and
in the synthesis processing, the low frequency component of the audio signal to which the compression processing is performed and a predetermined frequency band component of the audio signal are synthesized.

26. The signal processing method according to claim 24 further performing:
band pass filter processing to extract a predetermined frequency band component between the low frequency component and the high frequency component of the left and right audio signals, and
monaural synthesis processing to synthesize the audio signal that a left audio signal is multiplied by 0.5 and the audio signal that a right audio signal is multiplied by 0.5,
wherein, in the low pass filter processing, the low frequency component of the audio signal to which the monaural synthesis processing is performed is extracted,
in the compression processing, the audio signal to which the low pass filter processing is performed is compressed when the audio signal to which the low pass filter processing is not less than the predetermined signal level,
in the high pass filter processing, the high frequency component of the left and right audio signals is extracted,
in the first volume processing, the left and right audio signals are attenuated, and
in the synthesis processing, the low frequency component of the audio signal to which the compression processing is performed and the predetermined frequency band component of the left audio signal are synthesized and the low frequency component of the audio signal to which the compression processing is performed and the predetermined frequency band component of the right audio signal are synthesized.

27. The signal processing method according to claim 24 further performing:
band pass filter processing to extract a predetermined frequency band component between the low frequency component and the high frequency component of the audio signal that the left audio signal is multiplied by 0.5 and extract a predetermined frequency band component of the audio signal that the right audio signal is multiplied by −0.5,
monaural synthesis processing to synthesis the audio signal that the left audio signal is multiplied by 0.5 and the audio signal that the right audio signal is multiplied by 0.5, and
delay processing to delay the left and right audio signals to which the band pass filter processing is performed,
wherein, in the low pass filter processing, the low frequency component of the audio signal to which the monaural synthesis processing is performed is extracted,
in the compression processing, the audio signal to which the low pass filter processing is performed is compressed when the audio signal to which the low pass filter processing is performed is not less than the predetermined signal level,
in the high pass filter processing, the high frequency component of the left and right audio signals is extracted,
in the first volume processing, the left and right audio signals are attenuated, and
in the synthesis processing, the low frequency component of the audio signal to which the compression processing is performed and the predetermined frequency band component of the left and right audio signals to which the delay processing is performed are synthesized.
